(19) United States
(12) Patent Application Publication
(10) Pub. No.: US 2023/0320351 A1
(43) Pub. Date: Oct. 12, 2023

(54) ANTIBACTERIAL AND ANTIVIRAL FABRIC, FORMULATION FOR SOFT COATING AND METHOD OF FABRICATING THE SAME

(71) Applicant: Nano and Advanced Materials Institute Limited, Hong Kong (HK)

(72) Inventors: Wah Kit CHEUK, Hong Kong (HK); Shi Min TAN, Hong Kong (HK); Cheuk Ka POON, Hong Kong (HK); Chun Hay KO, Hong Kong (HK); Wing Man CHAN, Hong Kong (HK)

(21) Appl. No.: 18/296,962

(22) Filed: Apr. 6, 2023

Related U.S. Application Data
(60) Provisional application No. 63/329,493, filed on Apr. 11, 2022.

(51) Int. Cl. A01N 25/34; A01N 55/02; A01N 47/44; A01N 25/24; A01P 1/00; A01P 3/00

(52) U.S. Cl. CPC A01N 25/34; A01N 55/02; A01N 47/44; A01N 25/24; A01P 1/00; A01P 3/00

(57) ABSTRACT

The present invention provides an antibacterial and antiviral fabric includes a fabric substrate and an antimicrobial coating. The antimicrobial coating formed on the fabric substrate having an antimicrobial agent embedded or surface-adherent in a three dimensional porous network of nano-binder particles. The three dimensional porous network is formed by connecting the nano-binder particles to each other via van der Waals force or coulombic force. The antibacterial and antiviral fabric has an antimicrobial effect of at least 99% while maintaining physical properties comparable to an uncoated fabric. The present invention also provides an antibacterial and antiviral formulation and a method of preparing antibacterial and antiviral nanoparticles.

### CROSS-REFERENCE TO RELATED APPLICATIONS

The present application claims the priorities from the U.S. provisional patent application Ser. No. 63/329,493 filed Apr. 11, 2022, and the disclosure of which is incorporated herein by reference in its entirety.

### TECHNICAL FIELD

The present invention relates to a nano-binder particle coating. In particular, the present invention relates to an antibacterial and antiviral fabric, and antibacterial and antiviral formulation for soft surface. The present invention also relates to antibacterial and antiviral nanoparticles and their preparation methods.

### BACKGROUND OF THE INVENTION

An antimicrobial coating contains an antimicrobial agent that kills, inhibits or reduces the ability of bacteria to grow on the surface of the coating. However, the performance of a conventional antimicrobial coating highly depends on its binding system and coating substrate. Antimicrobial performance will be affected if the coating is not compatible with the substrate. For instance, a rigid antimicrobial coating film is not suitable for a soft surface because the mechanical properties misalign with soft substrate, and a coating with a conventional binding system (intact layer) blocks the pore structure of the substrate and limits the mechanical motion of soft substrates. Therefore, there is a need for antimicrobial coating for soft surface, which is able to provide a high surface area for the antimicrobial agent to be sustainably released, with high porosity to absorb mechanical energy, and with high inter-particle linkage to provide flexible adhesion on the soft surface.

Previous antimicrobial hard coatings are described in “Durable Antimicrobial Coating Composition” (U.S. Pat. No. 9,957,396B2, CN105295558B and HK1213937A1) and “Durable, Germicide-Free and Antibacterial Coating” (US20140242363A1 & HK1196633A1). The antimicrobial performance of such antimicrobial hard coatings is effective against gram-positive (Staphylococcus aureus), gram-negative (Escherichia coli), and drug-resistant bacteria of Methicillin-resistant Staphylococcus aureus (MRSA) and Extended-spectrum beta lactamases (ESBL) Klebsiella pneumonia with 99.9% removal rate within 15 min, and accredited by third-party laboratories with antiviral (H1N1 with 99.9% removal rate within 10 min, test standard: JIS Z 2801), endospores-killing (Bacillus subtillis with 99.9% removal rate within 60 min, test standard: JIS Z 2801) and antifungal (no growth within 6 weeks, test standard: BS3900-G6:1989) effects. The coating has been proven to be antimicrobially effective for 9 months.

US patent U.S. Pat. No. 9,616,021B2 discloses zein nanoparticles formed by lyophilization to reduce the immunogenicity induced by large-size particles. The size of the particle ranges from 100 nm to 400 nm. The pH value of reaction solution is around 6.8 to 7.4. The concentration of zein particles containing active ingredients in the solution is around 10 mg/mL. The encapsulation efficiency of the zein particles is approximately 60% to 80% after freeze-drying.

US patent US20080147019A1 discloses an antimicrobial composition comprising a chitosan-based matrix with 0.01 wt % to 15 wt % metallic nanoparticles having the size of 1 nm to 250 nm. The chitosan or chitosan derivative compounds weigh totally at least 10 wt % in the matrix, and 0-10% crosslinking agents and up to about 60% of chemical or physical modifier agents. The chemical agent exhibits antimicrobial properties that either kill mircoorganisims or inhibit their growth on solid substrates.

PCT patent WO2016156939A1 discloses a composite containing aggregates of chitosan and zinc oxide nanoparticles for sun screen application. The zinc oxide particles are trapped in chitosan ionotropically crosslinked with tripolyphosphate. The viscosity of chitosan solution ranges from 200 cP to 800 cP and the particle size of zinc oxide is not greater than 100 nm. The size of aggregates is not greater than 100 μm.

US patent U.S. Pat. No. 8,349,343B2 discloses an antibacterial treatment on textile materials using polymer/chitosan core-shell particles dispersed in water. The polymer/chitosan core-shell particles are prepared by 0.1%-10% acid solution with vinyl monomer and in weight ratio with chitosan of 0.5-50 to 1 (w/w) and hydroperoxide initiator. The formed polymer particle suspension is coated on fabric by soaking. Then the coated fabric is padded and dried at 100° C. oven for 5 min. The final coating is formed by repeating above steps for several times and finally cured at 150° C. oven for 4 min.

Nevertheless, the particles/coating from the abovementioned prior arts involve complicated synthesis processes and the resulting particles/coating are not suitable for soft surface application. In addition, the prior arts fail to provide coatings with a high porosity and having a nanostructure. A solid film which is intact and rigid may block the porous structure of fabrics, and further affect the breathability and filtration property of the coated surfaces. Besides, these conventional coatings are easily peeled off after a period of usage, ultimately losing their function as they are inelastic and incompatible with soft surfaces.

Consequently, there is a need for developing an antimicrobial coating for soft substrate. The present invention addresses this need.

### SUMMARY OF THE INVENTION

In a first aspect, the present invention provides an antibacterial and antiviral (ABV) fabric including a fabric substrate and at least one antimicrobial coating formed on the fabric substrate. The coating formed on the fabric substrate having an antimicrobial agent embedded or surface-adherent in a three dimensional porous network of nano-binder particles.

In one embodiment, the antimicrobial agent includes at least two antimicrobial components selected from polyhexamethylene biguanide, chlorhexidine, zinc pyrithione, gallic acid, nisin, and silane quaternary ammonium compound. The antimicrobial coating having at least two antimicrobial components demonstrates a synergistic effect with fast action and long-lasting properties.

In one embodiment, the nano-binder particles include at least two binder components selected from chitosan, zein, gelatin, cellulose, alginate, pectin, acrylic latex, polyurethane, cyclodextrin, silicon dioxide, zinc oxide, titanium dioxide, copper oxide, and ferric oxide.

In one embodiment, the at least two antimicrobial components are embedded or surface-adherent in a three dimensional nano-binder system. A three dimensional network coating on a soft surface is generated by connecting the nano-binder particles to each other via van der Waals force or coulombic force, and these particles facilitate an unique structure due to the size of particle and surface properties.

In contrast to conventional binders, voids and channels in the three dimensional porous network allow air and moisture to permeate the fabric. Also, the three dimensional porous network of nano-binder particles absorb the compressive and tensile force by deforming the three dimensional porous network, and therefore increasing the film mechanical tolerance. Besides, the porous-structure also increases the exposure of antimicrobial components by providing a high surface area.

In one embodiment, the fabric substrate is selected from a polypropylene (PP) substrate, a polyethylene (PE) substrate, a polyester substrate, a cotton substrate, a nylon substrate, a spandex substrate, a cotton-polyester blend, a cotton-nylon blend and a cotton-spandex blend. The antimicrobial coating can be coated on soft substrates by spray coating, dip coating, doctor blade coating, pad-dry-cure coating or wiping. It should be understood that heat treatment is not required for curing such coating on the soft substrates.

In another embodiment, the three dimensional porous network has pores surrounded by the nano-binder particles and the three dimensional porous network has an average pore size of at least 50 nm.

In yet another embodiment, the antimicrobial agent is embedded in or surface-adherent to nano-binder particles to form antibacterial and antiviral nanoparticles having a particle size of 100 nm to 800 nm.

In another embodiment, the antibacterial and antiviral nanoparticles have a polydispersity of 0.05 to 0.5.

In one embodiment, the antibacterial and antiviral fabric is air-permeable with an increased surface area of at least about 1000% and a porosity of at least 1,000% compared to the uncoated fabric.

In one embodiment, the antibacterial and antiviral fabric has an antimicrobial effect of at least 99% while maintaining physical properties comparable to an uncoated fabric.

In a second aspect, the invention also relates to two antibacterial and antiviral coating formulations. One is formulated for direct spraying on the soft surface such as polymer, non-woven and fabric. Another one is formulated for adding into polymer ink for soft surface application.

In one embodiment, the present invention provides an antibacterial and antiviral formulation for soft surface having 0.01 wt % to 5 wt % of an antimicrobial agent; 0.01 wt % to 5 wt % of nano-binder particles along with a surfactant and a solvent.

In another embodiment, the antimicrobial agent has at least two antimicrobial components selected from polyhexamethylene biguanide, chlorhexidine, zinc pyrithione, gallic acid, nisin, and silane quaternary ammonium compound. The nano-binder particles have at least two binder components selected from chitosan, zein, gelatin, cellulose, alginate, pectin, acrylic latex, polyurethane, cyclodextrin, silicon dioxide, zinc oxide, titanium dioxide, copper oxide, and ferric oxide.

In yet another embodiment, the formulation further comprises a crosslinking agent selected from the group consisting of tripolyphosphate (TPP), glutaraldehyde, citric acid, adipic acid, 1,2,3,4-butanetetracarboxylic acid (BTCA), methoxy polyethylene glycol aldehyde and dimethylol dihydroxy ethylene urea, with an amount of 0.01 wt % to 1 wt %.

In another embodiment, the solvent includes a first solution and a second solution. The first solution is selected from water, ethylacetate, isopropyl alcohol, ethanol, acetic acid, ammonia or combinations thereof, and the second solution is selected from isopropyl myristate (IPM), isopropyl palmitate, oleic acid, almond oil, soybean oil or combinations thereof. The surfactant is selected from cetrimonium bromide (CTAB), polysorbate 20, polysorbate 80, sorbitan laurate, sorbitan oleate, polyglyceryl-6 caprylate, polyglyceryl-3 cocoate, polyglyceryl-4 caprate, polyglyceryl-6 ricinoleate or combinations thereof.

In one embodiment, the surfactant is 0.01 wt % to 10 wt %, and the solvent is 85.0 wt % to 99.5 wt %. In particular, the surfactant is 0.01 wt % to 10 wt %, the first solution is 85 wt % to 99.5 wt %, and the second solution is 0.01 wt % to 5 wt %.

In a third aspect, the present invention also provides a method of preparing antibacterial and antiviral nanoparticles, including:
step (a) providing a first mixture comprising at least one antimicrobial component, and at least one binder component;
step (b) homogenizing the first mixture; and
step (c) adding at least another antimicrobial component and at least another binder component and mixing with the first mixture to form a second mixture, wherein the antibacterial and antiviral nanoparticles are formed in the second mixture.

The antimicrobial component is embedded in or surface-adherent to the nano-binder particles to form the antibacterial and antiviral nanoparticles.

In one embodiment, the content of the antimicrobial component is 0.01 wt % to 5 wt % based on the weight of the second mixture, the content of the binder component is 0.01 wt % to 5 wt % based on the weight of the second mixture.

In one of the embodiments, the pressure of step (b) ranges from 0 bar to 1000 bar.

In another embodiment, the pressure of step (b) ranges from 200 bar to 700 bar.

In one of the embodiments, further including adding a surfactant in an amount of approximately 0.01 wt % to 10 wt % and a solvent in an amount of approximately 85.0 wt % to 99.5 wt % in either step (a) or step (c).

In one of the embodiments, step (b) further includes a heat treatment step at 40° C. to 70° C.

In one embodiment, the antimicrobial component includes polyhexamethylene biguanide, chlorhexidine, zinc pyrithione, gallic acid, nisin or silane quaternary ammonium compound, and the binder component includes chitosan, zein, gelatin, cellulose, alginate, pectin, acrylic latex, polyurethane, cyclodextrin, silicon dioxide, zinc oxide, titanium dioxide, copper oxide or ferric oxide.

The present invention has the following advantages:
(1) The present invention provides a coating having effective antimicrobial function, high durability and stability. The preparation of such coating is simple, and able to be cured or dried without heat treatment.
(2) The differences of particle filtration efficiency, air permeability, and moisture permeability between the coated fabric and the uncoated fabric are less than 10%, which means that the coated fabric retains similar physical properties as the uncoated fabric. That is, the nano-binder particles would not totally block the surface of the substrate.
(3) The coated substrate has nice air permeability and moisture permeability, which is beneficial to applying to personal protective equipment (e.g. facemask or disposable gown).
(4) The resulting coating has better compatibility with the soft substrate as well as high antimicrobial effect. Even after several times of washing, the coated substrate still retain high antimicrobial effect.

### BRIEF DESCRIPTION OF THE DRAWINGS

In the following detailed description, reference is made to the accompanying figures, depicting exemplary, non-limiting and non-exhaustive embodiments of the invention. So that the manner in which the above recited features of the present invention can be understood in detail, a more particular description of the invention, briefly summarized above, can be had by reference to the embodiments, some of which are illustrated in the appended figures. It should be noted, however, that the figures illustrate only typical embodiments of this invention and are therefore not to be considered limiting of its scope, for the invention can admit to other equally effective embodiments.

FIG. 1 illustrates a comparison of conventional binder coated on soft surface and nano-binder particle coated on soft surface;

FIG. 2 illustrates the procedure of the antibacterial and antiviral nanoparticles of Example 1-4;

FIG. 3 illustrates the procedure of the antibacterial and antiviral nanoparticles of Example 2-3;

FIG. 4A depicts the particle size distribution of the antibacterial and antiviral nanoparticles of Example 1-4;

FIG. 4B depicts the particle size distribution of the antibacterial and antiviral nanoparticles of Example 2-3;

FIG. 5 shows pictures of coated PP substrate, uncoated PP substrate, coated PE substrate, and uncoated PE substrate of Example 3;

FIG. 6 shows pictures of antibacterial and antiviral formulation of Example 1-4, the coated mask, and the coated disposable gown of Example 4;

FIG. 7 shows SEM images of PP substrate coated with antibacterial and antiviral nanoparticles ((a) amplification 5000×, (b) 20000×) and PE substrate coated with antibacterial and antiviral nanoparticles ((c) amplification 5000×, (d) 20000×);

FIG. 8 shows pictures of (a) PALAs MFP 1000 HPA filter test system, (b) the location for placing the sample, (c) the user interface, and (d) the test parameters;

FIG. 9 shows pictures of (a) FX 3360 portable air permeability tester, and (b) the test parameters;

FIG. 10 shows pictures of (a) TF 165B auto water vapour permeability tester, (b) permeability cup with sample, and (c) calculation method and test parameters;

FIG. 11 illustrates the process of screen printing procedure;

FIG. 12 illustrates the process of heat transfer printing procedure;

FIG. 13 shows pictures of (a) first antibacterial and antiviral ink of Example 7, (b) polyester substrate printed with the first antibacterial and antiviral ink, (c) second antibacterial and antiviral ink of Example 7, and (d) polyester substrate hot melt printed with the second antibacterial and antiviral ink;

FIG. 14A is a picture of Fabric Touch Tester;

FIG. 14B to FIG. 14F are graphs of the measured parameters;

FIG. 15 is a picture of zone of inhibition test of the antibacterial and antiviral formulation of Example 1-4;

FIG. 16 is a picture of zone of inhibition test of the antibacterial and antiviral formulation of Example 2-3;

FIG. 17 is a picture of zone of inhibition test of PP substrates coated with antibacterial and antiviral formulation; and

FIG. 18 is a picture of zone of inhibition test of polyester substrates coated with antibacterial and antiviral ink.

### DETAILED DESCRIPTION

Rigid antimicrobial coating film is not suitable for soft surface as the mechanical properties misalign with the soft substrate and coating with conventional binding systems blocks the pore structure of the substrate. Hence, the present invention provides an antibacterial and antiviral fabric, formulation for soft coating, and method of fabricating antibacterial and antiviral nanoparticles.

First, the antibacterial and antiviral fabric includes a fabric substrate and at least one antimicrobial coating. Particularly, the fabric is a soft substrate. It should be understood that the term “soft substrate” in the specification represents a substrate which is flexible, bendable and deformable.

Particularly, the fabric substrate is expected to include, but not limit to, a polypropylene substrate, a polyethylene substrate, a polyester substrate, a cotton substrate, a nylon substrate, a spandex substrate, a cotton-polyester blend, a cotton-nylon blend or a cotton-spandex blend. In one of the embodiments, the coated fabric is chosen for medical use.

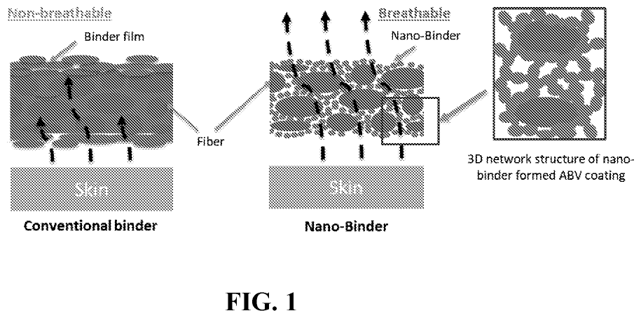

The antimicrobial coating formed on the fabric substrate having an antimicrobial agent embedded or surface-adherent in a three dimensional porous network of nano-binder particles, the schematic diagram of the three dimensional porous network is shown in FIG. 1.

The antimicrobial agent includes at least two antimicrobial components, which is expected to include, but not limit to, polyhexamethylene biguanide, chlorhexidine, zinc pyrithione, gallic acid, nisin, and silane quaternary ammonium compound.

The nano-binder particles include at least two binder components, which is expected to include, but not limit to, chitosan, zein, gelatin, cellulose, alginate, pectin, acrylic latex, polyurethane, cyclodextrin, silicon dioxide, zinc oxide, titanium dioxide, copper oxide, and ferric oxide.

In one of the embodiments, the particle filtration efficiency of the coated fabric is higher than the one of the uncoated fabric. Preferably, the coated fabric has at least 5% increase in particle filtration efficiency compared with the uncoated fabric, which is suitable for applying in hygiene products.

Preferably, the three dimensional network has pores surrounded by the nano-binder particles and the three dimensional network has an average pore size of at least 50 nm. The pores and voids formed in the coating allow the permeation of gas and moisture. The adjacent nano-binder particles are connected to each other by van der Waals force or coulombic force. Depending on the properties of the antimicrobial components and binder components, the pore size may range from 20 nm to 500 nm or 30 nm to 100 nm. Moderate pore size is important for breathing material, especially for facial masks.

The antimicrobial agent is embedded in or surface-adherent to nano-binder particles to form antibacterial and antiviral nanoparticles having a particle size of 100 nm to 800 nm or 100 nm to 600 nm.

The polydispersity of the nanoparticles ranges from 0.05 to 0.5 or 0.05 to 0.2.

The coated substrate has antimicrobial effect of at least 99% against E. coli, S. aureus, human coronavirus, B. subtilis, A. brasilensis, P. funiculosum, C. globosum, T. virens and A. pullulans. Further, the coated substrate is washable and demonstrates a high washing durability. The coated substrate after washing still retains its high antimicrobial effect. Preferably, the coated substrate after washing has an antimicrobial effect of 99.5% or more.

In one of the embodiments, the mechanical properties were similar between the coated substrate and the uncoated substrate, such as rigidity and surface parameters (e.g., surface roughness).

The coated substrate meets the requirement of chemical and biological safety which is suitable for personal protection equipment (PPE).

In one of the embodiments, the coated substrate has a coating weight of 0.05 g/cm² to 0.06 g/cm².

Second, the present invention also provides an antibacterial and antiviral formulation for soft surface. The antibacterial and antiviral formulation includes an antimicrobial agent, nano-binder particles, a surfactant, and a solvent. The antimicrobial agent may be embedded or surface-adherent by a three dimensional network of the nano-binder particles or simply dispersed in the formulation. The antibacterial and antiviral nanoparticle is essentially the nano-binder particles embedding or surface attaching the antimicrobial agent, and the particle size of the nanoparticle ranges from 100 nm to 800 nm. The antibacterial and antiviral formulation can be applied on soft substrates such as polypropylene substrates, polyethylene substrates, and polyester substrates.

Particularly, the antibacterial and antiviral formulation includes a 0.01 wt % to 5 wt % antimicrobial agent, 0.01 wt % to 5 wt % nano-binder particles, a surfactant, and a solvent. The antimicrobial agent has at least two antimicrobial components, which is expected to include, but not limit to, polyhexamethylene biguanide, chlorhexidine, zinc pyrithione, gallic acid, nisin, and silane quaternary ammonium compound. The nano-binder particles have at least two binder components, which is expected to include, but not limit to, chitosan, zein, gelatin, cellulose, alginate, pectin, acrylic latex, polyurethane, cyclodextrin, silicon dioxide, zinc oxide, titanium dioxide, copper oxide, and ferric oxide.

Preferably, the antimicrobial agent includes two antimicrobial components. The combination of such antimicrobial components may be a mixture of chlorhexidine and PHMB, or a mixture of chlorhexidine and zinc pyrithione. These combinations have high affinity to the nano-binder particles, which results in a greater antimicrobial effect.

Preferably, the nano-binder particle is a mixture of zein, chitosan, and zinc oxide or a mixture of zein and chitosan. When these nano-binder particles are coated on soft surfaces, the nano-binder particles can absorb the compressive and tensile forces by deforming the three dimensional network and thus increase the mechanical tolerance of the surface. Besides, the high area surface of the nano-binder particles contributes to the exposure of the antimicrobial agent, which creates a more significant antimicrobial effect.

Preferably, the surfactant is 0.01 wt % to 10 wt %, 0.01 wt % to 5 wt % or 0.01 wt % to 2 wt %, and the solvent is 85 wt % to 99.5 wt %, 90 wt % to 99.5 wt % or 92 wt % to 99.5 wt %.

Particularly, the solvent includes a first solution and a second solution. The first solution is expected to include, but not limit to, water, ethylacetate, isopropyl alcohol, ethanol, acetic acid, ammonia or combinations thereof. The second solution is expected to include, but not limit to, isopropyl myristate, isopropyl palmitate, oleic acid, almond oil, soybean oil or combinations thereof. Depending on the different solvents and surfactants, a water-in-oil emulsion system or oil-in-water emulsion system is performed. Preferably, the formulation is an oil-in-water system.

Preferably, the first solution is 85 wt % to 99.5 wt %, 90 wt % to 99.5 wt % or 92 wt % to 99.5 wt %, and the second solution is 0.01 wt % to 5 wt %, 0.01 wt % to 3 wt % or 0.01 wt % to 1 wt %.

Optionally, the formulation includes a crosslinking agent in range of 0.01 wt % to 1 wt %, 0.01 wt % to 0.5 wt % or 0.01 wt % to 0.1 wt %. The crosslinking agent is expected to include, but not limit to, tripolyphosphate, glutaraldehyde, critic acid, adipic acid, 1,2,3,4-butanetetracarboxylic acid, methoxy polyethylene glycol aldehyde or dimethylol dihydroxy ethylene urea. Preferably, the crosslinking agent is citric acid, adipic acid, genipin or 1,2,3,4-butanetetracarboxylic acid (BTCA), which is a suitable crosslinker for formulations applied to personal protective equipment since such crosslinking agents are non-poisonous materials.

The antibacterial and antiviral formulation is coated on a substrate by spray coating, dip coating, doctor blade coating, pad-dry-cure coating or wiping. The substrate may be, but is not limited to, a polypropylene substrate, a polyethylene substrate, a polyester substrate, a cotton substrate, a nylon substrate, a spandex substrate, a cotton-polyester blend, a cotton-nylon blend or a cotton-spandex blend.

Third, the present invention also provides a method of preparing the antibacterial and antiviral nanoparticles:
Step (a): a first mixture having at least one antimicrobial component and at least one binder component is provided.
Step (b): the first mixture is homogenized.
Step (c): at least another antimicrobial component and at least another binder component is added to form a second mixture; the antibacterial and antiviral nanoparticles are formed in the second mixture.

The antimicrobial component is expected to include, but not limit to, polyhexamethylene biguanide, chlorhexidine, zinc pyrithione, gallic acid, nisin or silane quaternary ammonium compound, and the binder component is chitosan, zein, gelatin, cellulose, alginate, pectin, acrylic latex, polyurethane, cyclodextrin, silicon dioxide, zinc oxide, titanium dioxide, copper oxide or ferric oxide.

The weight of the antimicrobial components is 0.01 wt % to 5 wt % based on the weight of the second mixture, the weight of the binder components is 0.01 wt % to 5 wt % based on the weight of the second mixture.

In one embodiment, the first mixture includes at least two antimicrobial components, and at least one binder component. In another embodiment, the first mixture includes at least one antimicrobial component, and at least two binder components. In another embodiment, the first mixture includes at least two antimicrobial components, and at least two binder components.

In the step (b), depending on the particle size of the nanoparticles, the pressure of the homogenization ranges from 0 bar to 1000 bar or 200 bar to 700 bar, the time of the homogenization ranges from 20 min to 60 min or 20 min to 40 min, and the speed of homogenization ranges from 1000 rpm to 2000 rpm. The speed of homogenization is optimized to maintain the desired particle size as well. Higher homogenization speeds can prevent the nanoparticles from aggregating. Usually, the high-speed and high-pressure homogenization method are used to create emulsion, which is oil-aqueous or aqueous-oil phase in the same liquid phase, and this method is seldom used to created solid particles.

In the step (b), heat treatment is optionally included. In one of the embodiments, the heat treatment ranges from 40° C. to 70° C. or 50° C. to 60° C. The heat treatment promotes particle formation in the first mixture having a nano-scale size and spherical shape.

The step (b) may further include an anti-solvent precipitation process. Preferably, the solvent used in the anti-solvent process is water. The anti-solvent precipitation process narrows the particle size distribution (polydispersity), which makes the nanoparticles more suitable for soft surfaces since uniform particle sizes contribute to controllable air permeability in the coated substrate.

Optionally, a surfactant is added in either the step (b) or step (c). The surfactant can lower the surface tension of the first mixture or the second mixture, and the nanoparticles formed in the second mixture will have a controllable size and shape. An increased amount of surfactant is also able to reduce the particle size.

### EXAMPLES

The examples and embodiments described herein are for illustrative purposes only and various modifications or changes in light thereof will be suggested to persons skilled in the art and are included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### Example 1

### Example 1-1

Preparation of 1 wt % Zein Solution

1 wt % zein in 80% ethanol solution was prepared by dissolving 1 g of zein into 99 g of 80% ethanol solution. The mixture was heated at 50° C. and stirred at 400 rpm for at least 30 minutes. The mixture was then cooled down to room temperature and filtered with a 0.45 μm nylon filter to remove undissolved residues. The 1 wt % zein solution was rendered.

### Example 1-2

Preparation of 0.1 wt % Chitosan/2 wt % Chlorhexidine Solution

0.1 g of low molecular weight (less than 100 kDa) chitosan was dissolved in 1% acetic acid solution, and the mixture was stirred at 400 rpm for at least 30 minutes. Then 2 g of chlorhexidine was added into the mixture and stirred at 400 rpm for at least 30 minutes. The 0.1 wt % chitosan/2 wt % chlorhexidine solution was rendered.

### Example 1-3

Preparation of 0.2 wt % Polyhexamethylene Biguanide (PHMB) Solution

0.2 wt % PHMB solution was prepared by dissolving 0.2 g of PHMB and 0.05 g of citric acid into 99.75 g of deionized water. Then the mixture was stirred at 400 rpm for at least 30 minutes. The 0.2 wt % PHMB solution was rendered.

### Example 1-4

Preparation of Antibacterial and Antiviral Formulation

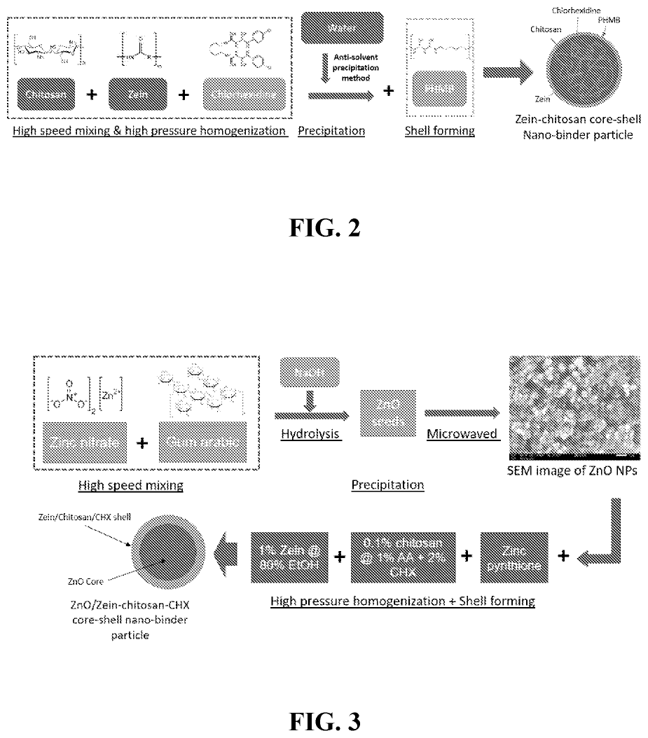

20 mL of 1 wt % zein solution was added into 1 mL of 0.1 wt % chitosan/2 wt % chlorhexidine solution. The mixture was heated at 50° C. for 5 minutes and high speed homogenized for 5 minutes to create a nano-binder mixture, then 0.02 g of cetrimonium bromide (CTAB) and 0.02 g of isopropyl myristate (IPM) were dissolved in the nano-binder mixture. The mixture was transferred to high pressure homogenization machine with 300 bar pressure for 30 min. The resulting homogenized solution was collected and 19 mL of 0.05 wt % citric acid aqueous solution was added into the homogenized solution and stirred at 600 rpm for at least 30 minutes. The nano-binder core particles were formed during the anti-solvent precipitation process. 4 mL of 0.2 wt % PHMB solution was added to decorate the nano-binder core particles to render the antibacterial and antiviral nanoparticles. The process is described in FIG. 2. The antibacterial and antiviral formulation of Example 1 is listed in Table 1.

### Example 2

### Example 2-1

Preparation of ZnO Nanoparticles

3 g of zinc nitrate was dissolved into 100 mL of water with 1 g of gum arabic as stabilizer and preheated by 450 W microwave for 2 minutes. Then the mixture was adjusted to pH 10 with 0.1 M sodium hydroxide solution. Amorphous ZnO precipitates were formed and turned the mixture into milky type. The mixture was then microwave-heated for 5 minutes to form ZnO nanoparticles. The ZnO nanoparticles were separated by centrifugation (10,000 rpm, 30 min) and the solid was dried overnight at 50° C.

### Example 2-2

Preparation of 1 wt % Zein Solution and 0.1 wt % Chitosan/2 wt % Chlorhexidine Solution

The preparations of 1 wt % zein solution and 0.1 wt % chitosan/2 wt % chlorhexidine solution were the same as the ones in Example 1.

### Example 2-3

Preparation of Antibacterial and Antiviral Formulation

0.1 g of ZnO nanoparticles, 0.1 g of zinc pyrithione, 0.05 g of CTAB and 0.05 g of IPM were weighed and added into 100 mL of 0.1 wt % chitosan/2 wt % chlorhexidine solution. The mixture was homogenized by high pressure homogenization machine with 300 bar pressure for 30 min. 2.5 mL of 1 wt % zein solution was added into the mixture and stirred for at least 30 minutes. The antibacterial and antiviral nanoparticles were formed during the anti-precipitation process of zein solution. The antibacterial and antiviral formulation of Example 2 was listed in Table 1. The fabrication procedure is shown in FIG. 3.

TABLE 1

| | Example 1 | Example 2 |
|---|---|---|
| chlorhexidine (wt %) | 0.045 | 1.946 |
| PHMB (wt %) | 0.018 | — |
| zinc pyrithione (wt %) | — | 0.097 |
| zein (wt %) | 0.454 | 0.024 |
| chitosan (wt %) | 0.002 | 0.097 |
| ZnO (wt %) | — | 0.097 |
| acetic acid (wt %) | 0.023 | 0.973 |
| ethanol (wt %) | 36.331 | 1.945 |
| deionized water (wt %) | 63.015 | 94.723 |
| IPM (wt %) | 0.045 | 0.049 |
| CTAB (wt %) | 0.045 | 0.049 |
| citric acid (wt %) | 0.022 | — |

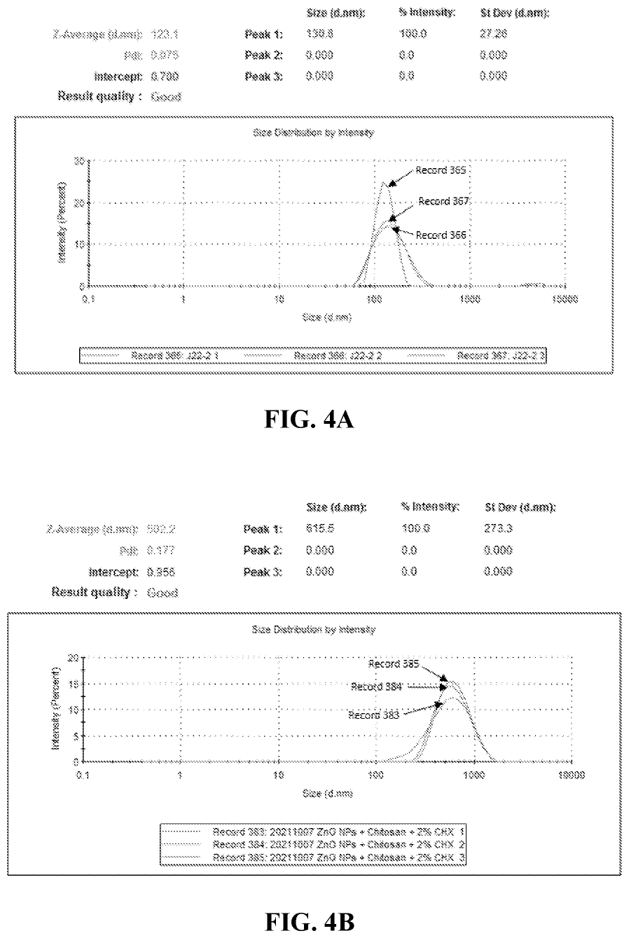

The particle size and polydispersity of the antibacterial and antiviral nanoparticles of Example 1-4 and Example 2-3 measured by Zetasizer were listed in the Table 2 and the graph of size distribution were shown in the FIGS. 4A and 4B, respectively.

TABLE 2

| | |
|---|---|
| Particle size (z-average, nm) | Polydispersity (PDI) |

Example 1-4

| | | |
|---|---|---|
| Measurement 1 | 123.1 | 0.075 |
| Measurement 2 | 139.7 | 0.163 |
| Measurement 3 | 138.5 | 0.161 |
| Average: | 133.8 | |

Example 2-3

| | | |
|---|---|---|
| Measurement 1 | 502.2 | 0.177 |
| Measurement 2 | 554.9 | 0.137 |
| Measurement 3 | 594.6 | 0.159 |
| Average: | 550.6 | |

### Example 3

Preparation of Antibacterial and Antiviral Substrates

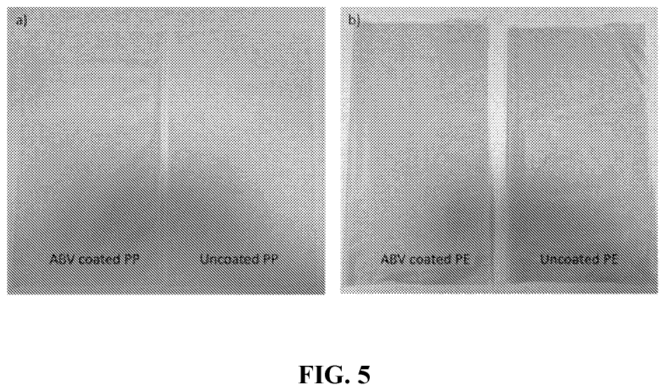

Polypropylene (PP) and polyethylene (PE) substrates were mounted on the paper cardboard. 20 mL of the antibacterial and antiviral formulation of Example 1-4 was filled to the reservoir of the spray gun. The spray distance was set to be 15 cm apart from the PP or PE substrate surface. The solution was sprayed horizontally from left to right then up to down as one layer of coating. Three layers were coated onto each substrate to render antibacterial and antiviral substrate. The appearances of the coated substrates are shown in FIG. 5.

### Example 4

Preparation of Antibacterial and Antiviral Facemask and Disposable Gown

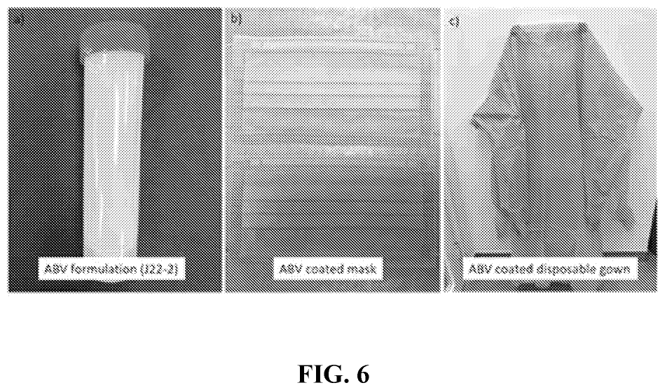

The antibacterial and antiviral formulation of Example 1-4 was spray-coated on facemask made of PP and disposable gown made of PE respectively. The products were shown in FIG. 6.

### Example 5

Coating Morphology of the Antibacterial and Antiviral Substrates

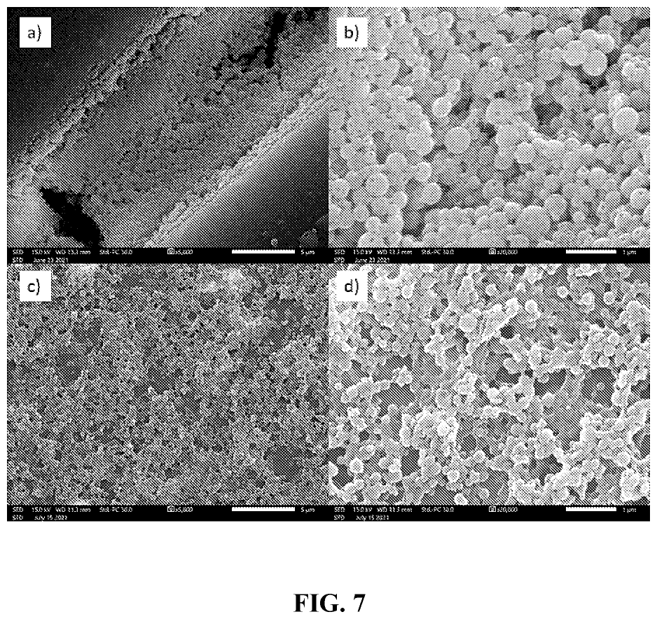

The coating morphology evaluation was conducted by SEM. The antibacterial and antiviral substrates were cut into size of 1 cm×1 cm and placed on a copper holder mounted with carbon tape. The samples were coated with gold for conducting propose. Images from different locations of the sample were captured with different magnifications as shown in FIG. 7. 5 samples of each Example was captured and at least 100 pores of each sample were recorded. The average pore size was calculated from the measurement of 100 pores of each sample.

The SEM images of the antibacterial and antiviral substrates were captured (as shown in FIG. 7) and the pore size of the samples was measured by SEM. The average pore size of 5 samples (averaged from 100 pores) of antibacterial and antiviral substrates were listed in the Table 3 below.

TABLE 3

| | PP substrate (pore size, nm) | PE substrate (pore size, nm) |
|---|---|---|
| Sample 1 | 79 | 69 |
| Sample 2 | 70 | 71 |
| Sample 3 | 70 | 64 |
| Sample 4 | 76 | 62 |
| Sample 5 | 73 | 64 |
| Average: | 74 | 66 |

### Example 6

Physical properties of the antibacterial and antiviral substrates

Physical Property Evaluation of the Antibacterial and Antiviral Substrates Included particle filtration efficiency test, air permeability test and moisture permeability test.

The PP substrate and PE substrate were prepared for the following tests. The PP substrate and PE substrate were the same as the antibacterial and antiviral substrates obtained in Example 3 without coating the antibacterial and antiviral formulation.

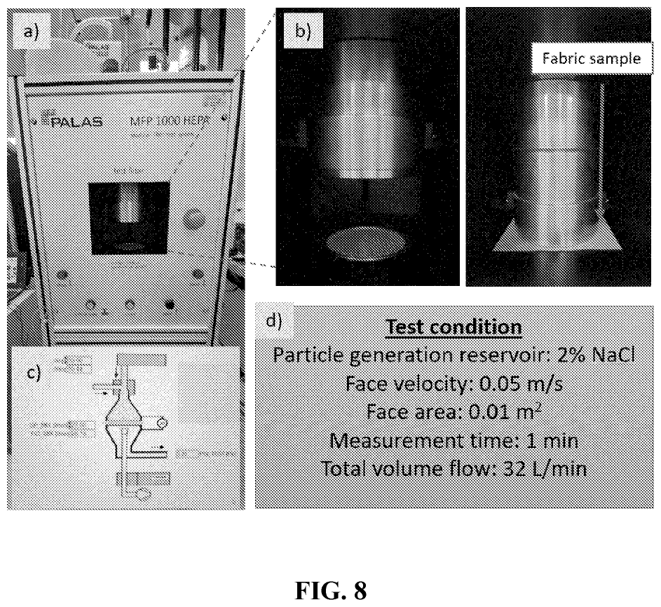

In the particle filtration efficiency (PFE) test, the antibacterial and antiviral substrates (PP and PE), uncoated PP substrate, and uncoated PE substrate were tested with PALAS MFP 1000 HPA filter test system as shown in FIG. 8. Each sample was placed and held on the stage of the machine (top right). Particles ranging from 0.1 to 3 um were generated by the testing machine with 2% sodium chloride solution and flown through the tested sample at a constant speed of 0.05 m/s for 1 minute. The sample testing area was set to be 0.01 m². The filtration results were compared with the net particles flown through the test chamber and obtained the filtration efficiency. Particles of 0.3 um were used in the test as 0.3 um was generally regarded as the most penetrating particle size (MPPS). The results were listed in Table 4.

TABLE 4

| | PFE at | Average PFE at | Percentage |
|---|---|---|---|
| Substrate | 0.3 μm (%) | 0.3 μm (%) | change |
| Coated | 70.77 | 73.4 ± 2.3 | ↑6.7% |
| PP* | 74.61 | | |
| | 74.90 | | |
| Uncoated | 70.09 | 68.7 ± 1.3 | Control group |
| PP* | 67.53 | | |
| | 68.71 | | |
| Coated PE | 93.11 | 92.12 ± 1.1 | ↓1.25% |
| | 92.32 | | |
| | 90.94 | | |
| Uncoated | 92.92 | 93.29 ± 2.4 | Control group |
| PE | 95.91 | | |
| | 91.05 | | |

*The substrate was coated another PP melt blown layer on it.

The antibacterial and antiviral PE substrate and the uncoated PE substrate showed higher particle filtration efficiency. The particle filtration efficiency of both samples reached above 90%. The particle filtration efficiency of the antibacterial and antiviral PE substrate only showed a 1.25% reduction compared with the control group.

On the other hand, the antibacterial and antiviral PP substrate and the uncoated PP substrate showed lower particle filtration efficiency. The particle filtration efficiency of both samples only reached above 68%. The particle filtration efficiency of the antibacterial and antiviral PP substrate showed a 6.7% increase in particle filtration efficiency compared with the control group. Both PP and PE samples had minimal change in particle filtration efficiency (i.e. less than 10%) after coating of the antibacterial and antiviral formulation of the present invention.

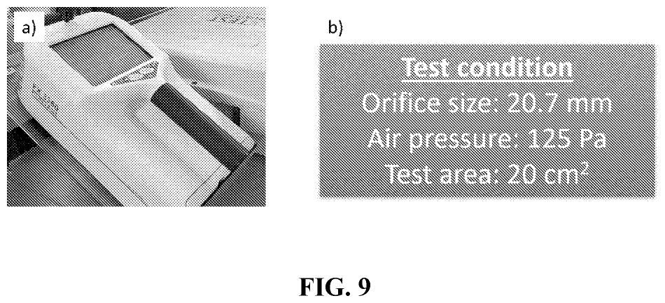

In the air permeability test, the antibacterial and antiviral PP substrates, the antibacterial and antiviral PE substrates, uncoated PP substrate, and uncoated PE substrate were tested with the FX 3360 portable air permeability tester as shown in FIG. 9. Orifice sizes of 20.7 mm and 0.5 mm were selected respectively for measuring different substrates of material, to obtain suitable airflow and pressure (125 Pa) for measurement. The test area was fixed to be 20 cm² for all substrates. Air permeability was measured with the airflow through the tested samples.

The results were shown in the Table 5.

TABLE 5

| | | Air | Average air | Percentage |
|---|---|---|---|---|
| | | permeability | permeability | change |
| Test condition | Substrate | (cm³/cm²/s) | (cm³/cm²/s) | (%) |
| Orifice size: | Coated PP | 369 | 382 ± 2 | ↓2% |
| 20.7 mm | | 359 | | |
| Air pressure: | | 357 | | |
| 125 Pa | Uncoated | 393 | 388 ± 5 | Control |
| Test area: 20 cm² | PP | 383 | | group |
| | | 389 | | |
| Orifice size: | Coated PE | 0.210 | 0.211 ± 0.012 | ↓1.6% |
| 0.5 mm | | 0.223 | | |
| Air pressure: | | 0.200 | | |
| 125 Pa | Uncoated | 0.197 | 0.214 ± 0.016 | Control |
| Test area: 20 cm² | PE | 0.217 | | group |
| | | 0.229 | | |

The antibacterial and antiviral PP substrate and the uncoated PP substrate showed relatively high air permeability. The air permeability of both samples reached above 380 cm³/cm²/s. The antibacterial and antiviral PP substrate showed a 2% reduction of air permeability compared with the control group. On the other hand, the antibacterial and antiviral PE substrate and the uncoated PE substrate showed lower air permeability. The permeability of both samples was around 0.2 cm³/cm²/s. The antibacterial and antiviral PE substrate showed a 1.6% reduction in air permeability compared with the control group. Both PP and PE samples met the requirement of less than 10% change in air permeability of substrates after coating the antibacterial and antiviral formulation of the present invention.

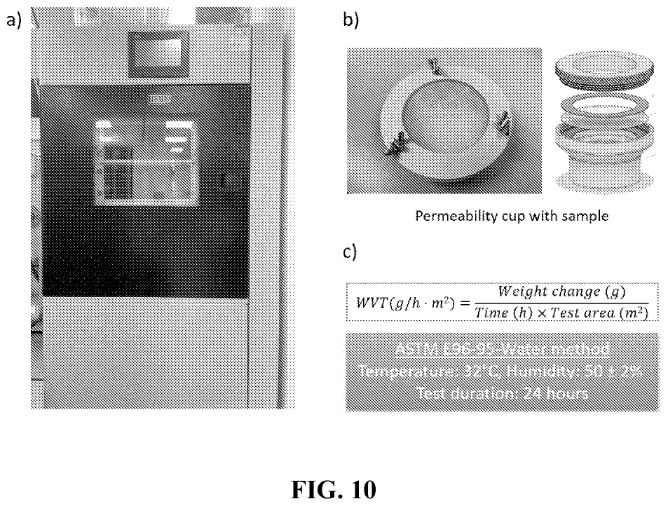

In the moisture permeability test, the antibacterial and antiviral PP substrates, the antibacterial and antiviral PE substrates, the uncoated PP substrate, and the uncoated PE substrate of were tested with TF 165B auto water vapour permeability tester as shown in FIG. 10. 20 mL of water was first loaded into each permeability cup before being mounted with sample substrates. The weight of the permeability cup loaded with sample substrate and water was recorded before placing the cup into the testing chamber (32° C., humidity 50±2%) for 24 hours. After 24 hours, the weight of the permeability cup with the sample substrate and the remaining water was measured again and the water vapour transmission rate (WVT) was calculated by the equation

$$( WVT = \frac{Weight change ( g )}{Time ( h ) * Test area ( {m}^{2} )} )$$

in FIG. 10c. The results were shown in the Table 6.

TABLE 6

| | WVT | Average WVT | Percentage |
|---|---|---|---|
| Substrate | (g/h · m²) | (g/h · m²) | change |
| Coated | 118 | 121 ± 3 | ↓2.7% |
| PP | 120 | | |
| | 124 | | |
| Uncoated | 120 | 124 ± 4 | Control group |
| PP | 128 | | |
| | 125 | | |
| Coated | 0.72 | 0.65 ± 0.06 | ↑8.6% |
| PE | 0.60 | | |
| | 0.62 | | |
| Uncoated | 0.60 | 0.57 ± 0.04 | Control group |
| PE | 0.53 | | |
| | 0.59 | | |

The antibacterial and antiviral PP substrate and the uncoated PP substrate had higher moisture permeability. The moisture permeability of both samples reached above 120 g/h·m².

The antibacterial and antiviral PP substrate showed a 2.7% reduction in the moisture permeability compared with the control group. On the other hand, the antibacterial and antiviral PE substrate and the uncoated PE substrate had relatively low moisture permeability. The moisture permeability of both samples reached above 0.57 g/h·m². The antibacterial and antiviral PE substrate showed an 8.6% increase in moisture permeability compared with the control group. Both PP and PE samples met the requirement of less than 10% change in moisture permeability of substrates after coating the antibacterial and antiviral formulation of the present invention.

### Example 7

Preparation of Antibacterial and Antiviral Ink

10 g of the antibacterial and antiviral formulation of Example 2-3 was weighed and added into 90 g of PU-based inks (heat-curing ink for screen printing and hot-melt ink for hot-melt printing) and 0.1 g of PHMB was added into the mixture and mixed evenly. The resulting two antibacterial and antiviral inks were stored in a sealable container respectively and avoided direct sunlight and heat sources.

### Example 8

Preparation of Antibacterial and Antiviral Substrates

### Example 8-1

For screen printing, 100 g of antibacterial and antiviral heat-curing ink of Example 7 was loaded onto the screen with designed printing pattern. The ink was wiped from up to down across the printing pattern on the screen to apply to a 100% polyester substrate. The process was repeated for 3 cycles to form a layer on the substrate for the antimicrobial test. The coated polyester substrate was transferred into a 50° C. oven for curing for 15 minutes. Then the antibacterial and antiviral substrate was rendered. The screen printing process was illustrated in FIG. 11.

### Example 8-2

For hot melt printing, the antibacterial and antiviral hot-melt ink of Example 7 was loaded into the ink cartridge of an ink-jet printer to print the designed pattern on heat transfer paper. The printed pattern on the heat transfer paper was allowed to cure. Hot melt powder was added on the pattern and heated at 180° C. to form a hot melt layer. The heat transfer paper was then placed on a 100% polyester substrate on the hot press machine. The pattern was heat-transferred on the polyester substrate (as shown in FIG. 12). Then the antibacterial and antiviral substrate was rendered.

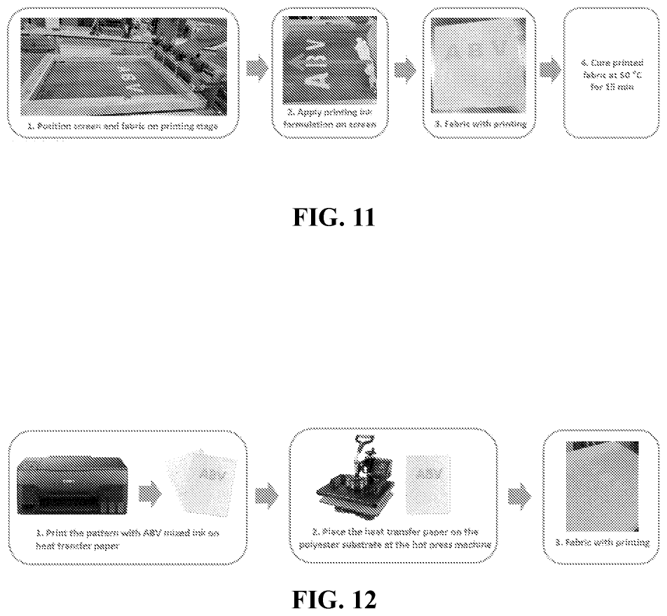

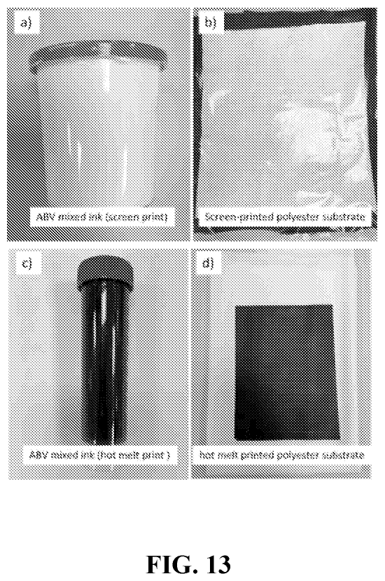

The pictures of the antibacterial and antiviral heat-curing ink, the antibacterial and antiviral hot-melt ink, and two antibacterial and antiviral substrates were shown in FIG. 13.

### Example 9

Texture Parameters of the Antibacterial and Antiviral Substrates

The polyester (PE) substrate was prepared for the following tests. The PE substrate was the same as the antibacterial and antiviral PE substrate without coating of the antibacterial and antiviral formulation of Example 2.

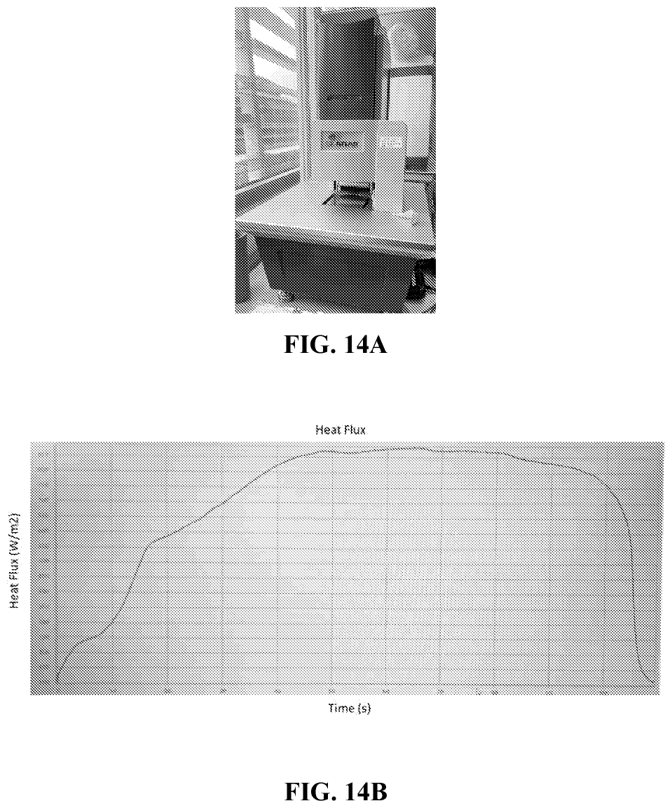

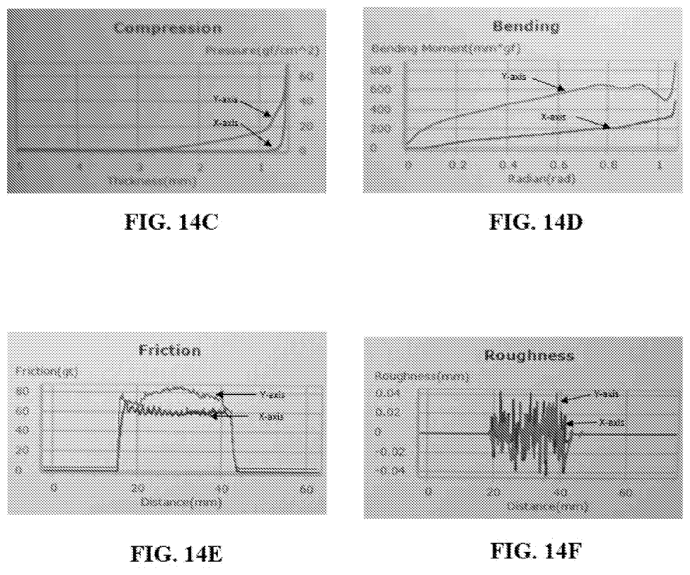

The texture parameters (rigidity, bending, friction and roughness) of the antibacterial and antiviral PE substrate and uncoated PE substrate were determined by Fabric Touch Tester as shown in FIG. 14A.

The samples were cut into L-shape and placed on the testing stage of Fabric Touch Tester. The programme and the probe were drawn down into the machine. The texture parameters were recorded by the sensors.

The rigidity (extent to withstand bending and compression to maintain the shape) in the software was represented by “compression” as shown in FIG. 14C. These parameters were affected by coating thickness and curing time of the coating. The parameters of the antibacterial and antiviral substrate and polyester substrate were measured and recorded in Table 7. The change in texture parameters (Compression+8%, Bending+10%, Friction −1%, and Roughness −7%) was less than 10% compared with the control group.

TABLE 7

| Texture | | | | Percentage |
|---|---|---|---|---|
| parameter | Substrate | value | Average | change |
| Rigidity | Coated PE | 442.73 | 488.77 ± 79.10 | ↑8% |
| (Compression) | | 411.79 | (gf*mm) | |
| | | 510.53 | | |
| | | 590.01 | | |
| | Uncoated | 441.53 | 454.21 ± 59.26 | Control group |
| | PE | 463.04 | (gf*mm) | |
| | | 384.41 | | |
| | | 527.85 | | |
| Bending | Coated PE | 25.27 | 49.43 ± 33.39 | ↑10% |
| | | 21.55 | (gf*mm/rad) | |
| | | 57.72 | | |
| | | 93.18 | | |
| | Uncoated | 49.65 | 44.93 ± 5.81 | Control group |
| | PE | 41.99 | (gf*mm/rad) | |
| | | 49.91 | | |
| | | 38.19 | | |
| Friction | Coated PE | 0.259 | 0.267 ± 0.01 | ↓1% |
| | | 0.274 | (newton) | |
| | | 0.265 | | |
| | | 0.268 | | |
| | Uncoated | 0.277 | 0.268 ± 0.01 | Control group |
| | PE | 0.258 | (newton) | |
| | | 0.256 | | |
| | | 0.282 | | |
| Roughness | Coated PE | 73.29 | 66.40 ± 10.15 | ↓7% |
| | | 51.87 | (um) | |
| | | 73.46 | | |
| | | 67.00 | | |
| | Uncoated | 38.79 | 71.36 ± 22.36 | Control group |
| | PE | 83.82 | (um) | |
| | | 87.80 | | |
| | | 75.01 | | |

### Example 10

Zone of Inhibition Test

A preliminary antimicrobial zone of inhibition test was performed on a paper disc with solution samples of the antibacterial and antiviral formulation of the present invention. A sterile paper disc with 5-6 mm diameter was used and placed on an S. aureus inoculated agar surface (0.1 mL of S. aureus solution at a concentration of 10⁶-10⁷ cfu/mL). 20 μL of solution sample was added onto the disc. The agar plate was then incubated at 37° C. incubator for at least 16 hours. A clear zone was formed if the tested sample had an antimicrobial effect. A clear zone greater than 1 mm diameter was positive to antimicrobial effect. The results of Examples 1 and 2 were described as follows.

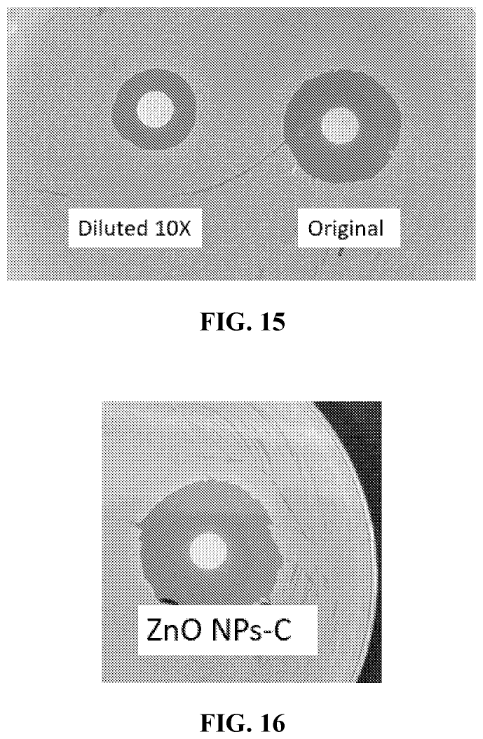

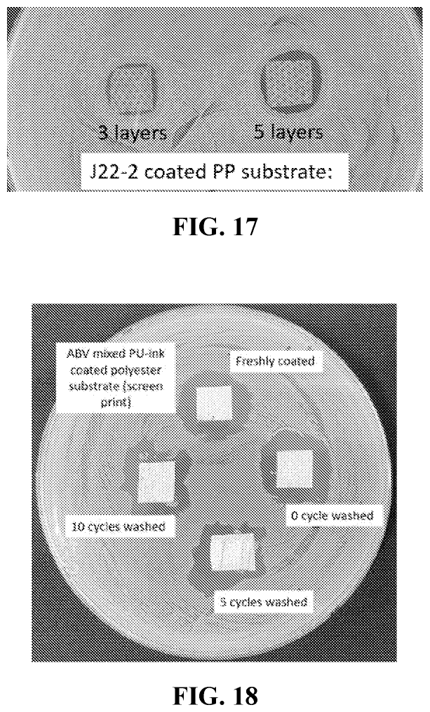

The paper disc coated with antibacterial and antiviral formulation of Example 1 was underwent a zone of inhibition test, and clear zone (around 5 mm) was presented (as shown in FIG. 15). The paper disc coated with antibacterial and antiviral formulation of Example 2 was underwent a zone of inhibition test, and clear zone was presented (as shown in FIG. 16). The PP substrate coated with 3 layers of coating formed by antibacterial and antiviral formulation of Example 1 and PP substrate coated with 5 layers of coating formed by antibacterial and antiviral formulation of Example 1 were underwent a zone of inhibition test, and the results were shown in FIG. 17.

Four samples of the antibacterial and antiviral PE substrate of Example 8-1 (freshly coated, 0 cycle washed, 5-cycle washed and 10-cycle washed) were cut into 2 cm×2 cm squares and placed onto an S. aureus inoculated agar plate (the freshly coated one and the 0 cycle washed one were essentially the same). Then, the agar plate with four samples was incubated at 37° C. incubator for at least 16 hours (as shown in FIG. 18). The washing condition (referenced from AATCC 61 with extra washing time and additional drying process) was 40° C. for 1 hour with 2 g of detergent (powder) from AATCC 1993 Standard Reference and 60° C. tumble dry process for 1 hour.

### Example 11

Antibacterial Effect of Antibacterial and Antiviral PP Substrate (Test Conducted by SGS)

The antibacterial effect of the antibacterial and antiviral PP substrate was tested in accordance with international standard ASTM E 2149-20 targeting on E. coli and S. aureus. The tested substrates showed greater than 99% antibacterial effect against E. coli and S. aureus. The reduction value was calculated based on comparison with control group (Table 8).

TABLE 8

| | The number of bacteria recovered from | | | |
|---|---|---|---|---|
| | (CFU/mL) | | | |
| | | | 1 h | |
| | | | contact | Reduc- |
| Name of test organism | / | initial | time | tion |
| Staphylococcus aureus | Sample (1.0 g) | / | <30 | >99% |
| ATCC 6538 | Control group | 2.7 × 10⁵ | 2.8 × 10⁵ | |
| Escherichia coli | Sample (1.0 g) | / | <30 | >99% |
| ATCC 25922 | Control group | 2.2 × 10⁵ | 2.4 × 10⁵ | |

### Example 12

Antiviral Effect of Antibacterial and Antiviral PP Substrate (Test Conducted by SGS)

The antiviral effect of the antibacterial and antiviral PP substrate was tested in accordance with international standard ISO 18184: 2019(E) targeting human coronavirus (HCoV-229E). The tested substrate showed greater than 99.99% antiviral effect against human coronavirus (Table 9).

TABLE 9

| | | Logarithm of | Logarithm of | Logarithm of |
|---|---|---|---|---|
| | | infectivity titre | infectivity titre | infectivity titre |
| | | value immediate | value after 1 h | value after 1 h |
| | | after inoculation | contacting with | contacting with |
| | | of the reference | the reference | the test |
| Virus and host cell | No. | specimen | specimen | specimen |
| Human coronaviruses | 1 | 6.71 | 6.63 | <1.80 |
| (HCoV-229E) | 2 | 6.73 | 6.59 | <1.80 |
| (ATCC VR-740) | 3 | 6.63 | 6.69 | <1.80 |
| Host cell: Vero | | | | |

| | | | |
|---|---|---|---|
| Average logarithm of infectivity | 6.69 | 6.64 | <1.80 |
| titre value (lg TCID₅₀/vial) | | | |

| | |
|---|---|
| Antiviral efficacy value | >4.89 |
| Antiviral activity rate (%) | >99.99 |

### Example 13

Antifungal Effect of Antibacterial and Antiviral PP Substrate (Test Conducted by Bureau Veritas)

The antifungal effect of the antibacterial and antiviral PP substrate was tested in accordance with international standard ASTM G21-15 targeting A. brasilensis, P. funiculosum, C. globosum, T. virens and A. pullulans. No tested fungi were grown on the surface of the substrate (>9900 antifungal effect) (Table 10).

It is noted that antiviral efficacy value is represented in log reduction. For example, log reduction of 2 represents a 990% reduction, and log reduction of 3 represents a 99.900 reduction.

TABLE 10

| | Rating of Observation | | |
|---|---|---|---|
| Day | Specimen 1 | Specimen 2 | Specimen 3 |
| Day 7 | 0 | 0 | 0 |
| Day 14 | 0 | 0 | 0 |
| Day 21 | 0 | 0 | 0 |
| Day 28 | 0 | 0 | 0 |

| | |
|---|---|
| Overall | 0 |

Remark: Rating of growth referto the follwing

| Observed growth on specimen | Rating |
|---|---|
| None | 0 |
| Traces of growth (less than 10%) | 1 |
| Light growth (10-30%) | 2 |
| Medium growth (30-60%) | 3 |
| Heavy growth (60% to complete coverage) | 4 |

### Example 14

Anti-Endospore Effect of Antibacterial and Antiviral PP Substrate (Test Conducted by Bureau Veritas)

The anti-endospore effect of the antibacterial and antiviral PP substrate was tested in accordance with international standard JIS Z 2801: 2012 targeting B. subtilis. The obtained anti-endospore result was log₁₀ 3.85 reduction, which represents >99.900 anti-endospore efficiency (Table 11).

TABLE 11

| | Bacillus |
|---|---|
| Result: | subtills |
| Average of logarithm number of viable bacteria | Log₁₀ 5.06 |
| immediately after inoculation on the untreated test piece | |
| (U₀) | |
| Average of logarithm number of viable bacteria after | Log₁₀ 4.85 |
| inoculation on the untreated test piece after 24 hrs (Uₜ) | |
| Average of logarithm number of viable bacteria after | Log₁₀ 1.00 |
| inoculation on substrate E1C-1 after 24 hrs (Aₜ) | |
| Antimicrobial activity (R) | Log₁₀ 3.85 |

Calculation of equation: R = (Uₜ − U₀) − (Aₜ − U₀)

### Example 15

Antimicrobial Property of PE Substrate Coated with the Antibacterial and Antiviral Formulation of the Present Invention

Antimicrobial property evaluation for polyester substrate coated with the antibacterial and antiviral formulation of the present invention was performed in-house using zone of inhibition test. Plate method (referenced by ASTM E 2149 or AATCC 100) was performed to evaluate the microbial removal test. Polyester substrate with coating of antibacterial and antiviral formulation and uncoated polyester substrate were tested. 0.5-2 g of coated or uncoated sample was added into 250 mL Erlenmeyer flask with 50 mL of S. aureus solution at a concentration of 1.5×10⁵-3×10⁵ cfu/mL and incubated at 37° C. with shaking for 18-24 hours. After incubation, the bacterial solutions were diluted to different dilution factor and inoculated on agar plate. The plates were incubated at 37° C. for at least 16 hours. The bacterial colonies formed on the agar plate were counted and recorded. Bacterial removal percentage was obtained by comparing with the blank control (PE substrate without coating).

The antibacterial and antiviral substrate of Example 8-1 was sent to obtain accredited antimicrobial certificates in accordance with international standards. Antibacterial tests (after 10 washing cycles), such as ASTM E 2149, targeting E. coli and S. aureus were conducted. Anti-endospore test, such as JIS 2801 targeting B. subtilis was conducted. Antifungal test, such as ASTM G21-15 or JIS Z 2911, targeting 4-5 fungus species was conducted. Antiviral test, such ISO18184, targeting human coronavirus was conducted.

### Example 16

Antiviral Effect of Antibacterial and Antiviral PE Substrate (Test Conducted by SGS)

The antiviral effect of the antibacterial and antiviral PE substrate of Example 8-1 was tested in accordance with international standard ISO 18184: 2019(E) targeting human coronavirus (HCoV-229E) at accredited laboratory. The tested substrate showed 99.93% antiviral effect against human coronavirus (Table 12).

TABLE 12

| | | Logarithm of | Logarithm of | |
|---|---|---|---|---|
| | | infectivity titre | infectivity titre | Logarithm of |
| | | value immediate | value after 1 h | infectivity titre |
| | | after inoculation | contacting with | value after 1 h |
| | | of the reference | the reference | contacting with |
| Virus and host cell | No. | specimen | specimen | the test specimen |
| Human coronaviruses | 1 | 6.71 | 6.63 | 3.63 |
| (HCoV-229E) | 2 | 6.73 | 6.59 | 3.50 |
| (ATCC VR-740) | 3 | 6.63 | 6.69 | 3.42 |
| Host cell: Vero | | | | |

| | | | |
|---|---|---|---|
| Average logarithm of infectivity | 6.69 | 6.64 | 3.52 |
| titre value (lg TCID₅₀/vial) | | | |

| | |
|---|---|
| Antiviral efficacy value | 3.17 |
| Antiviral activity rate (%) | 99.93 |

### Example 17

Antifungal Effect of Antibacterial and Antiviral PE Substrate (Test Conducted by Bureau Veritas)

The antifungal effect of the antibacterial and antiviral PE substrate of Example 8-1 was tested in accordance with international standard ASTM G21-15 targeting A. brasilensis, P. funiculosum, C. globosum, T. virens and A. pullulans. No tested fungi were grown on the surface of the substrate (>9900 antifungal effect) (Table 13).

TABLE 13

| | Rating of Observation | | |
|---|---|---|---|
| Day | Specimen 1 | Specimen 2 | Specimen 3 |
| Day 7 | 0 | 0 | 0 |
| Day 14 | 0 | 0 | 0 |
| Day 21 | 0 | 0 | 0 |
| Day 28 | 0 | 0 | 0 |

| | |
|---|---|
| Overall | 0 |

Remark: Rating of growth referto the follwing

| Observed growth on specimen | Rating |
|---|---|
| None | 0 |
| Traces of growth (less than 10%) | 1 |
| Light growth (10-30%) | 2 |
| Medium growth (30-60%) | 3 |
| Heavy growth (60% to complete coverage) | 4 |

### Example 18

Anti-Endospore Effect of Antibacterial and Antiviral PE Substrate (Test Conducted by Bureau Veritas)

The anti-endospore effect of the antibacterial and antiviral PE substrate of Example 8-1 was tested in accordance with international standard JIS Z 2801: 2012 targeting B. subtilis at accredited laboratory. The obtained anti-endospore result was log₁₀ 3.26 reduction, which represents >99.9% anti-endospore efficiency (endospore removal rate) (Table 14).

TABLE 14

| | Bacillus |
|---|---|
| Result: | subtills |
| Average of logarithm number of viable bacteria | Log₁₀ 5.37 |
| immediately after inoculation on the untreated test piece | |
| (U₀) | |
| Average of logarithm number of viable bacteria after | Log₁₀ 4.26 |
| inoculation on the untreated test piece after 24 hrs (Uₜ) | |
| Average of logarithm number of viable bacteria after | Log₁₀ 1.00 |
| inoculation on the antimicrobial test piece after 24 hrs (Aₜ) | |
| Antimicrobial activity (R) | Log₁₀ 3.26 |

Calculation of equation: R = (Uₜ − U₀) − (Aₜ − U₀)

### Example 19

Washability of Antibacterial and Antiviral Polyester Substrate

The polyester substrate coated with the antibacterial and antiviral formulation of Example 2 was washed according to international standard such as, AATCC 61 A1. The washing condition of AATCC 61 was shown in Table 15. The coated substrate was washed at 40° C. for 45 minutes with 0.37 g of washing powder in 200 mL water with 10 steel balls. The antibacterial effect was evaluated after 5 and 10 washing cycles and the results were shown in FIG. 18 and Table 15.

TABLE 15

| | | | | Percent | Percent | Percent | | | |
|---|---|---|---|---|---|---|---|---|---|
| | | | Total | Powder | Liquid | Available | | | |
| | Temp | | Liquor | Detergent | Detergent | Chlorine | No. | No. of | |
| Test | ° C. | ° F. | Volume | of Total | of Total | of Total | Steel | Rubber | Time |
| No. [symbol] | (±°2) | (±°4) | (mL) | Volume | Volume | Volume | Balls | Balls | (Min) |
| 1A | 40 | 105 | 200 | 0.37 | 0.56 | None | 10 | 0 | 45 |
| 1B [symbol] | 31 | 88 | 150 | 0.37 | 0.56 | None | 0 | 10 | 20 |
| 2A | 49 | 120 | 150 | 0.15 | 0.23 | None | 50 | 0 | 45 |
| 3A | 71 | 160 | 50 | 0.15 | 0.23 | None | 100 | 0 | 45 |
| 4A | 71 | 160 | 50 | 0.15 | 0.23 | 0.015 | 100 | 0 | 45 |
| 5A | 49 | 120 | 150 | 0.15 | 0.23 | 0.027 | 50 | 0 | 45 |

[symbol]

indicates data missing or illegible when filed

Antibacterial effect of the coated polyester substrate accordance to industrial standard (i.g. ASTM E 2149) after 10 washing cycles (i.g. ASTM E3162-18).

Antibacterial effect of coated polyester substrate after 10 washing cycles following AATCC 61 A1 condition was tested with E. coli and S. aureus referencing international standard ASTM E 2149. The results were shown in Table 16. The obtained antibacterial results were greater than 9900 for both E. coli and S. aureus.

TABLE 16

| Target | | | Average | Removal rate |
|---|---|---|---|---|
| Bacteria | Substrate | CFU/mL | CFU/mL | (%) |
| E. coli | Coated PE | 0 | 0 | >99.9% |
| | (after 10 washes) | 0 | | |
| | | 0 | | |
| | Uncoated PE | 40,700 | 43,300 | Control group |
| | | 42,700 | | |
| | | 46,500 | | |
| S. aureus | Coated PE | 0 | 0 | >99.9% |
| | (after 10 washes) | 0 | | |
| | | 0 | | |
| | Uncoated PE | 38,700 | 35,400 | Control group |
| | | 31,000 | | |
| | | 36,800 | | |

The coated polyester substrate was tested by Bureau Veritas to obtain the extra validation in antibacterial performance in accordance with international standard ASTM E 2149 after 10 washing cycles.

TABLE 17

| | Counts (CFU/mL) | |
|---|---|---|
| | Escherichia | Staphylococcus |
| | coli | aureus |
| Name of bacteria used for test | ATCC 25922 | ATCC 6538 |
| CFU/mL for the flask containing the | less than 1 | less than 1 |
| treated substrate after 24 hrs contact | | |
| time (A) | | |
| CFU/mL for the “inoculum only” flask | 720,000 | 233,000 |
| after 24 hrs contact time (B) | | |
| CFU/mL for the “inoculum only” flask | 220,000 | 181,000 |
| at initial concentration (B2) | | |
| CFU/mL for the flask containing the | 455,000 | 50,000 |
| untreated substrate after 24 hrs contact | | |
| time (C) | | |
| Percent reduction (%) | >99.9 | >99.9 |

Method of Laundering: AATCC61-2A (2 cycles of wash), 1 cycle represent 5 home launderings
Remark: Percent reduction (%) = [(C − A)/C)] × 100%

The antibacterial and antiviral formulations of Examples 1-4 (Group 1) and 2-3 (Group 2), antibacterial and antiviral PP substrates (Group 3) and PE substrates (Group 4) and antibacterial and antiviral PE substrates of Example 8-1 (Group 5) were tested at accredited third-party laboratories for assessing the chemical and biological safety. The results were shown in the Table 18.

TABLE 18

| | | | USP 467 (Class | | Acute |
|---|---|---|---|---|---|
| | | | 1 residual | Skin | dermal |
| | RoHS* | SVHC* | solvents)** | irritation*** | toxicity*** |
| Group 1 | Pass | Pass | Pass | — | — |
| Group 2 | Pass | Pass | Pass | — | — |
| Group 3 | — | — | — | Pass | Pass |
| Group 4 | — | — | — | Pass | Pass |
| Group 5 | — | — | — | Pass | Pass |

*RoHS & SVHC were performed at Intertek Testing Services HK Ltd.
**USP 467 was performed at Castco Testing Centre Limited.
***Skin irritation and Acute dermal toxicity were performed by SGS.

The antibacterial and antiviral formulations were sent for testing against the restricted or banned hazardous substances listed in RoHS and SVHC. The amount of the substances detected did not exceed the allowable limits. The antibacterial and antiviral formulations were tested against VOC content according to the USP 467 (Class 1 residual solvents). The residual solvents detected did not exceed the allowable limits. The antibacterial and antiviral substrates were tested against skin irritation on the skin of patient with test patch. The testing method followed in-house method from accredited testing laboratory. No or negligible irritation was observed. The antibacterial and antiviral substrates were tested with contact acute toxicity to provide information on health hazards that might be arised from short-term chemical exposure through dermal route. No or negligible contact acute toxicity was observed.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to +5%, less than or equal to +4%, less than or equal to +3%, less than or equal to ±2%, less than or equal to +1%, less than or equal to ±0.5%, less than or equal to +0.1%, or less than or equal to +0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

1. An antibacterial and antiviral fabric, comprising
a fabric substrate;
at least one antimicrobial coating formed on the fabric substrate, the antimicrobial coating comprises an antimicrobial agent having at least two antimicrobial components embedded or surface-adherent in a three dimensional porous network of nano-binder particles, wherein the three dimensional porous network is formed by connecting the nano-binder particles to each other via van der Waals force or coulombic force,
wherein the nano-binder particles comprise at least two binder components selected from the group consisting of chitosan, zein, gelatin, cellulose, alginate, pectin, acrylic latex, polyurethane, cyclodextrin, silicon dioxide, zinc oxide, titanium dioxide, copper oxide, and ferric oxide; and
wherein the antibacterial and antiviral fabric has an antimicrobial effect of at least 99% while maintaining physical properties comparable to an uncoated fabric.

2. The antibacterial and antiviral fabric of claim 1, wherein the three dimensional porous network has pores surrounded by the nano-binder particles and the three dimensional porous network has an average pore size of at least 50 nm.

3. The antibacterial and antiviral fabric of claim 1, wherein the antimicrobial agent is embedded in or surface-adherent to the nano-binder particles to form antibacterial and antiviral nanoparticles with a particle size of 100 nm to 800 nm.

4. The antibacterial and antiviral fabric of claim 3, wherein the antibacterial and antiviral nanoparticles have a polydispersity of 0.05 to 0.5.

5. The antibacterial and antiviral fabric of claim 1, wherein the fabric substrate is selected from the group consisting of a polypropylene substrate, a polyethylene substrate, a polyester substrate, a cotton substrate, a nylon substrate, a spandex substrate, a cotton-polyester blend, a cotton-nylon blend, and a cotton-spandex blend.

6. The antibacterial and antiviral fabric of claim 1, wherein the at least two antimicrobial components are selected from the group consisting of polyhexamethylene biguanide, chlorhexidine, zinc pyrithione, gallic acid, nisin, and silane quaternary ammonium compound.

7. The antibacterial and antiviral fabric of claim 1, wherein the antibacterial and antiviral fabric is air-permeable with an increased surface area of at least about 1000% and a porosity of at least 1,000% compared to the uncoated fabric.

8. An antibacterial and antiviral formulation for soft surfaces, comprising
0.01 wt % to 5 wt % of an antimicrobial agent;
0.01 wt % to 5 wt % of nano-binder particles;
a surfactant and a solvent;
wherein the antimicrobial agent comprises at least two antimicrobial components selected from the group consisting of polyhexamethylene biguanide, chlorhexidine, zinc pyrithione, gallic acid, nisin, and silane quaternary ammonium compound; the nano-binder particles comprise at least two binder components selected from the group consisting of chitosan, zein, gelatin, cellulose, alginate, pectin, acrylic latex, polyurethane, cyclodextrin, silicon dioxide, zinc oxide, titanium dioxide, copper oxide, and ferric oxide.

9. The antibacterial and antiviral formulation of claim 8, wherein the content of the surfactant is approximately 0.01 wt % to 10 wt %, and the content of the solvent is approximately 85.0 wt % to 99.5 wt %.

10. The antibacterial and antiviral formulation of claim 8, wherein the antibacterial and antiviral formulation further comprises a crosslinking agent selected from the group consisting of tripolyphosphate, glutaraldehyde, critic acid, adipic acid, 1,2,3,4-butanetetracarboxylic acid, methoxy polyethylene glycol aldehyde, and dimethylol dihydroxy ethylene urea, with an amount of 0.01 wt % to 1 wt %.

11. The antibacterial and antiviral formulation of claim 8, wherein the solvent comprises a first solution and a second solution; the first solution is selected from water, ethylacetate, isopropyl alcohol, ethanol, acetic acid, ammonia, or combinations thereof, the second solution is selected from isopropyl myristate, isopropyl palmitate, oleic acid, almond oil, soybean oil, or combinations thereof, and the surfactant is selected from cetrimonium bromide, polysorbate 20, polysorbate 80, sorbitan laurate, sorbitan oleate, polyglyceryl-6 caprylate, polyglyceryl-3 cocoate, polyglyceryl-4 caprate, polyglyceryl-6 ricinoleate, or combinations thereof.

12. The antibacterial and antiviral formulation of claim 11, wherein the content of the surfactant is 0.01 wt % to 10 wt %, the content of the first solution is 85.0 wt % to 99.5 wt %, and the content of the second solution is 0.01 wt % to 5 wt %.

13. A method of preparing antibacterial and antiviral nanoparticles comprising:
step (a): providing a first mixture comprising at least one antimicrobial component, and at least one binder component;
step (b): homogenizing the first mixture;
step (c): adding at least another antimicrobial component and at least another binder component and mixing with the first mixture to form a second mixture, wherein the antibacterial and antiviral nanoparticles are formed in the second mixture;
wherein the content of the antimicrobial component is 0.01 wt % to 5 wt % based on the weight of the second mixture, the content of the binder component is 0.01 wt % to 5 wt % based on the weight of the second mixture,
wherein the antimicrobial component is embedded in or surface-adherent to the nano-binder particles to form the antibacterial and antiviral nanoparticles.

14. The method of claim 13, wherein the pressure of step (b) ranges from 0 bar to 1000 bar.

15. The method of claim 13, wherein the pressure of step (b) ranges from 200 bar to 700 bar.

16. The method of claim 13, further comprising adding a surfactant in an amount of approximately 0.01 wt % to 10 wt % and a solvent in an amount of approximately 85.0 wt % to 99.5 wt % in either step (a) or step (c).

17. The method of claim 13, wherein step (b) further comprises a heat treatment step at 40° C. to 70° C.

18. The method of claim 13, wherein the antimicrobial component comprises polyhexamethylene biguanide, chlorhexidine, zinc pyrithione, gallic acid, nisin or silane quaternary ammonium compound; and the binder component comprises chitosan, zein, gelatin, cellulose, alginate, pectin, acrylic latex, polyurethane, cyclodextrin, silicon dioxide, zinc oxide, titanium dioxide, copper oxide, or ferric oxide.
